(19) United States
(12) Patent Application Publication
(10) Pub. No.: US 2014/0286433 A1
(43) Pub. Date: Sep. 25, 2014

(54) HIERARCHICAL MOTION ESTIMATION FOR VIDEO COMPRESSION AND MOTION ANALYSIS

(71) Applicant: DOLBY LABORATORIES LICENSING CORPORATION, San Francisco, CA (US)

(72) Inventors: Yuwen He, San Diego, CA (US); Alexandros Tourapis, Milpitas, CA (US); Peng Yin, Ithaca, NY (US)

(73) Assignee: DOLBY LABORATORIES LICENSING CORPORATION, San Francisco, CA (US)

(21) Appl. No.: 14/349,590

(22) PCT Filed: Oct. 18, 2012
(86) PCT No.: PCT/US2012/060887

§ 371 Date: Apr. 3, 2014

Related U.S. Application Data
(60) Provisional application No. 61/550,280, filed on Oct. 21, 2011.

(51) Int. Cl. H04N 19/51; H04N 19/91; H04N 19/29

(52) U.S. Cl. CPC H04N 19/00696; H04N 19/00418; H04N 19/00951
USPC 375/240.16

(57) ABSTRACT

Systems and methods for hierarchical motion estimation are described. The hierarchical motion estimation may provide motion information and pixel correlation among temporal pictures at different resolutions, which may be utilized in motion related video processing applications such as video coding, motion compensation based denoising, interpolation, and others to improve the quality and/or speed of motion predictions. Systems and methods of video processing that include pre- and post-processing utilizing information from hierarchical motion estimations are also discussed. Specifically, systems and methods of video processing with hierarchical motion estimation instead of or in addition to other motion estimations are shown.

### CROSS REFERENCE TO RELATED APPLICATIONS

This application claims the benefit of U.S. Provisional Application No. 61/550,280, filed on Oct. 21, 2011, which is hereby incorporated by reference in its entirety. The present application is related to PCT Application with Serial No. PCT/US2012/060826, filed on Oct. 18, 2012, which is hereby incorporated by reference in its entirety.

### FIELD

The disclosure relates generally to video processing and video encoding. More specifically, it relates to video pre- and post-processing as well as video encoding that utilizes hierarchical motion estimation to analyze the characteristics of a video sequence, including, but not limited to, its motion information.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a block diagram of an exemplary video coding system.

FIG. 2 shows a block diagram of an embodiment of a video coding system that utilizes hierarchical motion estimation as an initial step for motion analysis.

FIG. 3 is a diagram showing an example of block-based motion prediction with a motion vector (mv_x, mv_y) for motion compensation based temporal prediction.

FIG. 4 is a diagram showing an exemplary hierarchical motion estimation (HME) engine framework for applying a layered motion search on multiple down-sampled layers of an input video.

FIG. 5 is a diagram showing another exemplary hierarchical motion estimation engine framework for applying a layered motion search on four down-sampled layers with a scaling factor of 2 in each of the x and y dimensions between layers for the input video picture.

FIG. 6A shows a diagram illustrating examples of the block positions where intra-layer MV predictors are derived. FIG. 6B shows a diagram illustrating examples of the block positions where inter-layer MV predictors are derived.

FIG. 7 is a flow chart showing an exemplary HME search framework.

FIG. 8 shows an exemplary HME search flowchart for a particular layer and a particular reference picture.

FIG. 9 shows an exemplary multiple region HME applied in parallel.

FIG. 10 shows an exemplary macroblock (MB) with four partitions of 8×8 pixels.

FIG. 11 shows exemplary predictors for several hierarchical layers, wherein predictors of one hierarchical layer are derived from predictors of another hierarchical layer.

FIG. 12 shows an example of fixed predictor locations based on and relative to a derived center location.

FIGS. 13A and 13B show exemplary block diagrams of a complementary sampling-frame compatible full resolution (CS-FCFR 3D) system (FIG. 13A) and a frame compatible full resolution 2-D (2D-FCFR 3D) system (FIG. 13B).

### DESCRIPTION OF EXAMPLE EMBODIMENTS

According to a first aspect of the disclosure, a method is provided for selecting a motion vector associated with a particular reference picture and for use with a particular region of an input picture in a sequence of pictures. The method comprises: a) providing the sequence of pictures, wherein each picture is adapted to be partitioned into one or more regions; b) providing a plurality of reference pictures from a reference picture buffer; c) for the particular reference picture in the plurality of reference pictures, performing motion estimation on the particular region based on the particular reference picture to obtain at least motion vector, wherein each motion vector is based on a predictor selected from the group consisting of a spatial intra-layer predictor, a temporal predictor, a fixed predictor, and a derived predictor; d) generating a prediction region based on the particular region and a particular motion vector among the at least one motion vector; e) calculating an error metric between the particular region and the prediction region; f) comparing the error metric with a set threshold; g) selecting the particular predictor if the error metric is below the set threshold, thus selecting the motion vector for motion compensated prediction associated with the particular reference picture and for use with the particular region; and h) iterating d) through g) for each remaining motion vector in the at least one motion vector and selecting a predictor associated with a error metric below the set threshold or a motion vector associated with a minimum error metric.

According to a second aspect of the disclosure, a method is provided for selecting a motion vector associated with a particular reference picture and for use with a particular region of an input picture in a sequence of pictures. The method comprises: a) providing the sequence of pictures, wherein each picture is adapted to be partitioned into one or more regions; b) providing a plurality of reference pictures from a reference picture buffer; c) for each input picture in the sequence of pictures, providing at least a first hierarchical layer and a second hierarchical layer, each hierarchical layer associated with each input picture in the sequence of pictures at a set resolution; d) providing motion information associated with the second hierarchical layer; e) for the particular reference picture in the plurality of reference pictures, performing motion estimation on the particular region at the first hierarchical layer based on the particular reference picture to obtain at least one first hierarchical layer motion vector, wherein each first hierarchical layer motion vector is based on a predictor selected from the group consisting of a spatial intra-layer predictor, an inter-layer predictor, a temporal predictor, a fixed predictor, and a derived predictor associated with the first hierarchical layer; f) generating a prediction region based on a particular first hierarchical layer motion vector and the particular region of the input picture; g) calculating an error metric between the particular region and the prediction region; h) comparing the error metric with a set threshold; i) selecting the particular first hierarchical layer motion vector if the error metric is below the set threshold, thus selecting the motion vector for motion compensated predictor associated with the particular reference picture and for use with the particular region; and j) iterating f) through i) for each remaining first hierarchical layer motion vector in the at least one first hierarchical layer motion vector and selecting a first hierarchical layer motion vector associated with an error metric below the set threshold or a first hierarchical layer motion vector associated with a minimum error metric.

According to a third aspect of the disclosure, a method is provided for performing hierarchical motion estimation on a particular region of an input picture in a sequence of pictures, each input picture adapted to be partitioned into one or more regions. The method comprises: a) providing a plurality of reference pictures from a reference picture buffer; b) performing downsampling and/or upsampling on the input picture at a plurality of spatial scales to generate a plurality of hierarchical layers, each hierarchical layer associated with the input picture at a set resolution; c) for a particular reference picture in the plurality of reference pictures, performing motion estimation on the particular region at a particular hierarchical layer based on the particular reference picture to obtain at least one motion vector, wherein each motion vector is based on a predictor selected from the group consisting of a spatial intra-layer predictor, an inter-layer predictor, a temporal predictor, a fixed predictor, and a derived predictor associated with the particular hierarchical layer; d) generating a prediction region based on a particular motion vector and the particular region at the particular hierarchical layer; e) calculating an error metric between the particular region and the prediction region; f) comparing the error metric with a set threshold; g) selecting the particular motion vector if the error metric is below the set threshold, thus selecting a motion vector associated with the particular reference picture and for use with the particular region; and h) iterating d) through g) for one or more remaining motion vectors in the at least one motion vector and selecting a motion vector associated with an error metric below the set threshold or a motion vector associated with a minimum error metric.

According to a fourth aspect of the disclosure, an encoder is provided. The encoder is adapted to receive input video data and output a bitstream. The encoder comprises: a hierarchical motion estimation unit configured to generate a plurality of motion vectors; a mode selection unit, wherein the mode selection unit is adapted to determine mode decisions based on the input video data and the plurality of motion vectors from the hierarchical motion estimation unit, and wherein the mode selection unit is adapted to generate prediction data from intra prediction and/or motion estimation and compensation; an intra prediction unit connected with the mode selection unit, wherein the intra prediction unit is adapted to generate intra prediction data based on the input video data; a motion estimation and compensation unit connected with the mode selection unit, wherein the motion estimation and compensation unit is adapted to generate motion prediction data based on reference data from a reference buffer and the input video data; a first adder unit adapted to take a difference between the input video data and the prediction data to provide residual information; a transforming unit connected with the first adder unit, wherein the transforming unit is adapted to transform the residual information to obtain transformed information; a quantizing unit connected with the transforming unit, wherein the quantizing unit is adapted to quantize the transformed information to obtain quantized information; and an entropy encoding unit connected with the quantizing unit, wherein the entropy encoding unit is adapted to generate the bitstream from the quantized information. The input video data to the encoder may comprise input pictures where each picture can be partitioned into one or more regions.

According to a fifth aspect of the disclosure, a system is provided for generating reference data, where the reference data are adapted to be stored in a reference buffer and the system is adapted to receive input video data. The system comprises: a hierarchical motion estimation unit configured to generate a plurality of motion vectors; a mode selection unit, wherein the mode selection unit is adapted to determine mode decisions based on the input video data and the plurality of motion vectors from the hierarchical motion estimation unit, and wherein the mode selection unit is adapted to generate prediction data from intra prediction and/or motion estimation and compensation; an intra prediction unit connected with the mode selection unit, wherein the intra prediction unit is adapted to generate intra prediction data based on the input video data; a motion estimation and compensation unit connected with the mode selection unit, wherein the motion estimation and compensation unit is adapted to generate motion prediction data based on reference data from a reference buffer and the input video data; a first adder unit adapted to take a difference between the input video data and the prediction data to provide residual information; a transforming unit connected with the first adder unit, wherein the transforming unit is adapted to transform the residual information to obtain transformed information; a quantizing unit connected with the transforming unit, wherein the quantizing unit is adapted to quantize the transformed information to obtain quantized information; an inverse quantizing unit connected with the quantizing unit, the inverse quantizing unit adapted to remove quantization performed by the quantizing unit, wherein the inverse quantizing unit is adapted to output non-quantized information; an inverse transforming unit connected with the inverse quantizing unit, the inverse transforming unit adapted to remove transformation performed by the transforming unit, wherein the inverse transforming unit is adapted to output non-transformed information; and a second adder unit adapted to add the non-transformed data with the prediction data to generate reconstructed data, wherein the reconstructed data are adapted to be stored in the reference buffer.

Motion information is utilized in video processing and compression. The present disclosure describes hierarchical motion estimation (HME) methods and related devices and systems that can provide reliable motion information for motion-related applications such as, by way of example and not of limitation, deinterlacing, denoising, super resolution, object tracking, and compression. The hierarchical motion estimation can also utilize motion correlation among different resolutions to derive the parameters of motion models such as translational, zoom, affine, perspective, and other warping models [reference 2, incorporated by reference in its entirety]. Further, the hierarchical motion estimation can be applied based on any shaped region.

One embodiment of the present disclosure describes utilization of HME in video coding applications. Video coding systems are used to compress digital video signals to reduce storage need and/or transmission bandwidth of such signals. There are many types of video coding systems, including but not limited to block-based, wavelet-based, region-based, and object-based systems. Among these, block-based systems are the most widely used and deployed. Examples of block-based video coding systems include international video coding standards and codecs such as MPEG-1/2/4, VC-1 [reference 1, incorporated by reference in its entirety], H.264/MPEG-4 AVC [reference 3, incorporated by reference in its entirety] and its Multi-View Video Coding (MVC) [Annex H, reference 3] and Scalable Video Coding (SVC) [Annex G, reference 3] extensions, and VP8 [reference 6, incorporated by reference in its entirety]. For this reason, this disclosure frequently refers to block-based video coding systems as an example in explaining the embodiments of the disclosure.

However, a person skilled in the art of video processing and coding will understand that the embodiments described herein can be applied to any type of video processing or coding system that uses motion compensation to reduce and/or remove inherent temporal redundancy in video signals. Hence, the block-based video coding system, while referred to, should be taken as an example and should not limit the scope of this disclosure. For example, the HME method described in the present application may be applicable to any type of processing (such as motion compensated temporal filtering) that utilizes motion estimation concepts and may also be applicable to video analysis for the purpose of segmentation, depth extraction, denoising, and others.

The H.264 standard for video compression [reference 3] mentioned above is a video standard that is applicable to areas such as multimedia storage, video broadcasting and consumer electronics products that may benefit from its generally high compression efficiency. However, H.264 video encoding may be complex due to its variety of coding modes. For example, the video encoding can involve consideration pertaining to: utilization of multiple partitions and combinations thereof, multiple references, different sub-pixel precisions, and others; use of bi-prediction; whether or not to perform weighted prediction; whether or not to perform rate-distortion optimized quantization; types of direct modes; decisions on deblocking; and so forth. Additionally, complexity is also related to how these modes are evaluated. By way of example, the modes can be evaluated by utilizing brute force methods, rate-distortion optimization, fast techniques in conjunction with low complexity rate-distortion optimization, distortion-only decisions, and so forth. Each of the possible modes may be evaluated and compared with each other in terms of, for example, a rate-distortion cost prior to selecting a mode or modes for use in coding, especially for better coding performance. It should also be noted that rate-distortion techniques are not required in a mode decision process, and thus a mode decision process can (but need not) take into consideration rate-distortion calculations.

Further, multi-layered codecs, such as MVC and SVC, employ both inter-layer and inter references. Unlike inter references, which are previously coded pictures belonging to a same layer (e.g., same base layer or same enhancement layer) as the current picture to be coded, inter-layer references correspond to pictures that belong to a prior or higher-priority layer of the current picture that may have, for example, a certain quality, resolution, bit depth, or even angle, e.g., for stereo or multi-view images, other than that of the current picture. One may wish to exploit the inter-layer characteristics for improving the performance and/or reducing the complexity of inter-layer or even inter motion estimation, such as by employing the HME based methods described in the present disclosure.

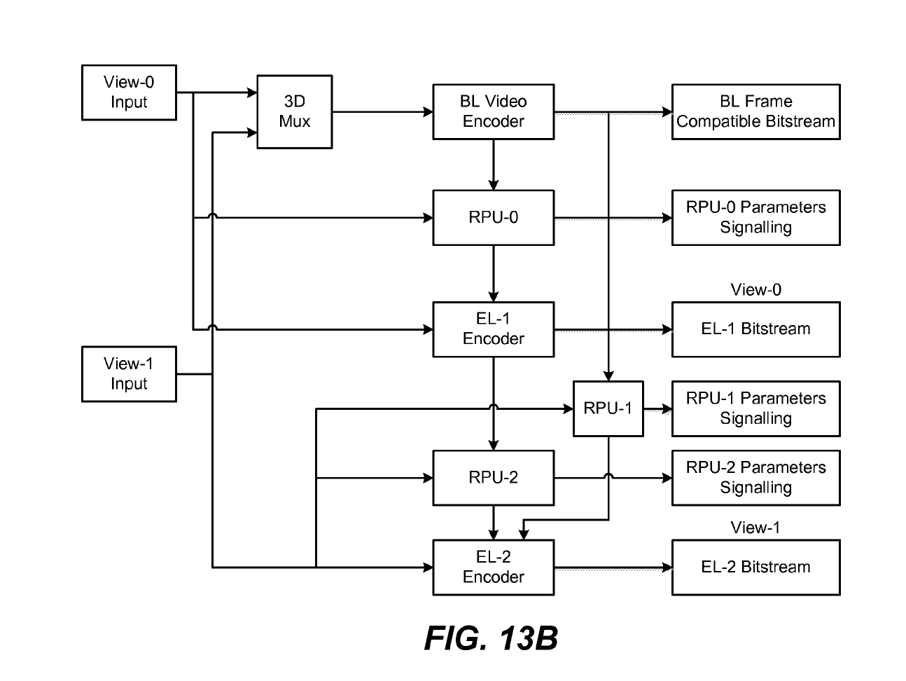

A special case of the multi-layered codecs including MVC is Dolby's Frame Compatible Full Resolution codec where additional layers may only differ in terms of sampling from other layers or may also differ in terms of resolution. The Dolby Frame Compatible Full Resolution (FCFR) coding schemes may include a complementary sampling arrangement, which is shown in FIG. 13A, and a multi-layered full resolution arrangement, which is shown in FIG. 13B. The multi-layered full resolution arrangement of Dolby's FCFR system resembles the MVC extension of MPEG-4 AVC, with a difference being that a frame compatible signal can now also be used as a base layer of the system, whereas additional improvements in performance can be achieved through a proprietary prediction process and its associated information. Such information can also be signaled in the bitstream. The MVC extension is described further in Annex H of reference 4. These coding methods may support emerging stereo applications, as well as provide spatial scalability or other types of scalability. It is also worth noting that HME may be used to address both complexity and quality of the motion estimation process in these applications.

Typically, motion estimation (ME) is used to derive the motion model parameters of a region by means of one or more matching methods, which is used to map the region from one picture to another picture. The models are often translational, but affine, perspective, and parabolic models are also possible, and the model parameters can have different precisions such as integer or fractional pixels. Multiple references as well as multiple hypotheses that are combined linearly or nonlinearly may also be used. Furthermore, motion models can also be combined with the derivation of weighting parameters due to illumination change. Motion estimation can also be performed with consideration to information such as quantization parameters (QP), lagrangian parameters, and so forth that relate to certain encoding behavior (e.g., information relating to a rate control process).

The motion estimation process can be an important, yet time-consuming component of video encoder systems and other motion related video processing such as motion compensated temporal filtering systems. Motion estimation can affect video compression performance because it can determine the efficiency of temporal prediction.

As used in this disclosure, the terms “picture”, “region”, and “partition” are used interchangeably and are defined herein to refer to image data pertaining to a pixel, a block of pixels (such as a macroblock or any other defined coding unit), an entire picture or frame, or a collection of pictures/frames (such as a sequence or subsequence). Macroblocks can comprise, by way of example and not of limitation, 4×4, 4×8, 8×4, 8×8, 8×16, 16×8, and 16×16 pixels within a picture. In general, a region can be of any shape and size. A pixel can comprise not only luma but also chroma components. Pixel data may be in different formats such as 4:0:0, 4:2:0, 4:2:2, and 4:4:4; different color spaces (e.g., YUV, RGB, and XYZ); and may use different bit precision.

As used in this disclosure, the terms “data” and “information” are used interchangeably. The terms “image/video data” and “image/video information” are defined herein to include one or more pictures, macroblocks, blocks, regions, or any other defined coding unit.

An exemplary method of segmenting a picture into regions, which can be of any shape and size, takes into consideration image characteristics. For example, a region within a picture can be a portion of the picture that contains similar image characteristics. Specifically, a region can be one or more pixels, macroblocks, objects, or blocks within a picture that contains the same or similar chroma information, luma information, and so forth. The region can also be an entire picture. As an example, a single region can encompass an entire picture when the picture in its entirety is of one color or essentially one color.

It is reiterated here that although various processes of the present disclosure are described in examples applied at the block level (e.g., block-based motion estimation), these processes can be applied, for example, to entire pictures as well as regions, partitions, macroblocks, blocks, or one or more pixels in general within a picture.

As used in this disclosure, the terms “current layer” and “current video picture/region” is defined herein to refer to a layer and a picture/region, respectively, currently under consideration.

As used in this disclosure, the term “hierarchical layer” or “h-layer” refers to a full set, a superset, or a subset of an input picture of video information for use in HME processes. Each h-layer may be at a resolution of the input picture (full resolution), at a resolution lower than the input picture, or at a resolution higher than the input picture. Each h-layer may have a resolution determined by the scaling factor associated to that h-layer, and the scaling factor of each h-layer can be different.

An h-layer can be of higher resolution than the input picture. For example, subpixel refinements may be used to create additional h-layers with higher resolution. The term “higher h-layer” is used interchangeably with the term “upper h-layer” and is defined herein to refer to an h-layer that is processed prior to processing of a current h-layer under consideration. Similarly, as used in this disclosure, the term “lower h-layer” is defined herein to refer to an h-layer that is processed after the processing of the current h-layer under consideration. It is possible for a higher h-layer to be at the same resolution as that of a previous h-layer, such as in a case of multiple iterations, or at a different resolution.

It is noted that a higher h-layer may be at the same resolution, for example, when reusing an image at the same resolution with a certain filter or when using an image at the same resolution using a different filter. The HME process can be iteratively applied if necessary. For example, once the HME process is applied to all h-layers, starting from the highest h-layer down to the lowest h-layer, the process can be repeated by feeding the motion information from the lowest h-layer again back to the highest h-layer as the initial set of motion predictors. A new iteration of the HME process can then be applied.

As used in this disclosure, the term “full resolution” refers to resolution of an input picture.

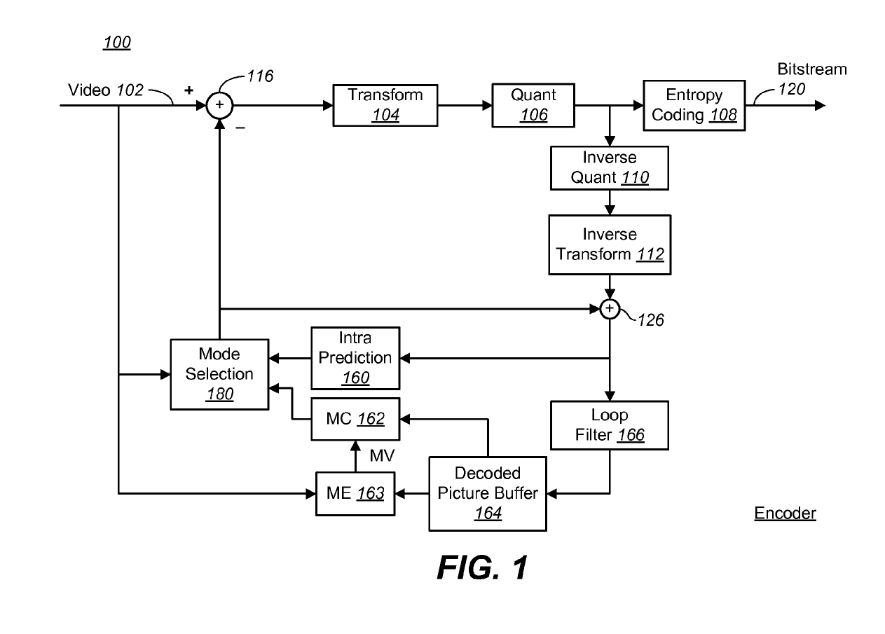

FIG. 1 shows a block diagram of an exemplary video coding system (100) for coding an input video signal (102). In the case of a block-based video coding system, for instance, the input video signal (102) can be processed block by block. A commonly used video block unit consists of 16×16 pixels. For each portion of input video data (e.g., picture, region, macroblock, block, or otherwise any defined coding unit) in the input video signal (102), intra prediction (160) and/or motion estimation (163) and motion compensation (162) may be applied as selected by a mode selection and control logic (180) to generate prediction data (e.g., a prediction picture, a prediction region, and so forth).

The prediction data can be subtracted from the corresponding portion of the original input video data (102) at a first adder unit (116) to form prediction residual data. The prediction residual data are transformed at a transforming unit (104) and quantized at a quantizing unit (106) for video coding. The quantized and transformed residual coefficient data can be sent to an entropy coding unit (108) to be entropy coded to further reduce bit rate. In some cases, the quantized and transformed residual coefficient data may be zero or may be so small such that the quantized and transformed residual coefficient data can be approximated and signaled as zero. The entropy coded residual coefficients can then be packed to form part of an output video bitstream (120).

The quantized and transformed residual coefficient data can be inverse quantized at an inverse quantizing unit (110) and inverse transformed at an inverse transforming unit (112) to obtain reconstructed residual data. Reconstructed video data can be formed by adding the reconstructed residual data to the prediction data at a second adder unit (126).

The reconstructed video data can be used as a reference for intra-prediction (160), which can also be referred to as spatial prediction (160). Before being stored in a decoded data buffer or reference data store (164), which can be a reference picture buffer for storing previously decoded pictures or regions thereof, the reconstructed video data may also go through additional filtering at a loop filter unit (166) (e.g., in-loop deblocking filter as in H.264/AVC). The reference data store (164) can be used for the coding of future video data in the same video picture/slice and/or in future video pictures/slices. For example, reference pictures or regions thereof from the reference data store (164) may be used for motion estimation (163) and compensation (162).

Temporal prediction, of which motion compensation (162) is an example, can utilize video data from neighboring video frames to predict current video data, and thus can exploit temporal correlation and remove temporal redundancy inherent in a video signal. Temporal prediction is also commonly referred to as “inter prediction”, which includes “motion prediction”. Like intra prediction (160), temporal prediction also may be applied on video data (e.g., video blocks of various sizes). For example, for the luma component, H.264/AVC allows inter prediction block sizes such as 16×16, 16×8, 8×16, 8×8, 8×4, 4×8, and 4×4 pixels. Inter prediction can also be applied by combining two or more prediction signals while it may also consider illumination change parameters, e.g., weighting parameters such as a weight and an offset [reference 3]. In H.264/AVC only up to two references can be combined to form a bi-predicted signal, whereas other codecs may combine together more than two references. In H.264, each prediction that may be used for bi-prediction is associated with a different list, e.g., LIST_{—}0 and LIST_{—}1.

Individual predictions generated from intra prediction (160) and/or motion compensation (162) can serve as input into a mode selection and control logic unit (180), which in turn generates prediction data based on the individual predictions. For example, the mode selection and control logic unit (180) can be a switch that switches between intra prediction (160) and motion compensation (162) based on image information.

As previously described, after prediction, the prediction data can be subtracted from the corresponding portion of the original input video data (102) at a first adder unit (116) to form prediction residual data. The prediction residual data are transformed at a transforming unit (104) and quantized at a quantizing unit (106). The quantized and transformed residual coefficient data are then sent to an entropy coding unit (108) to be entropy coded to further reduce bit rate. Thresholding may also be applied prior to any one of transforming (104), quantizing (106), or entropy coding (108) such that the representation of the residual information and/or distortion associated with the residual information can be compared with a set threshold value to determine whether the residual information is negligible or not negligible. The entropy coded residual coefficients are then packed to form part of an output video bitstream (120).

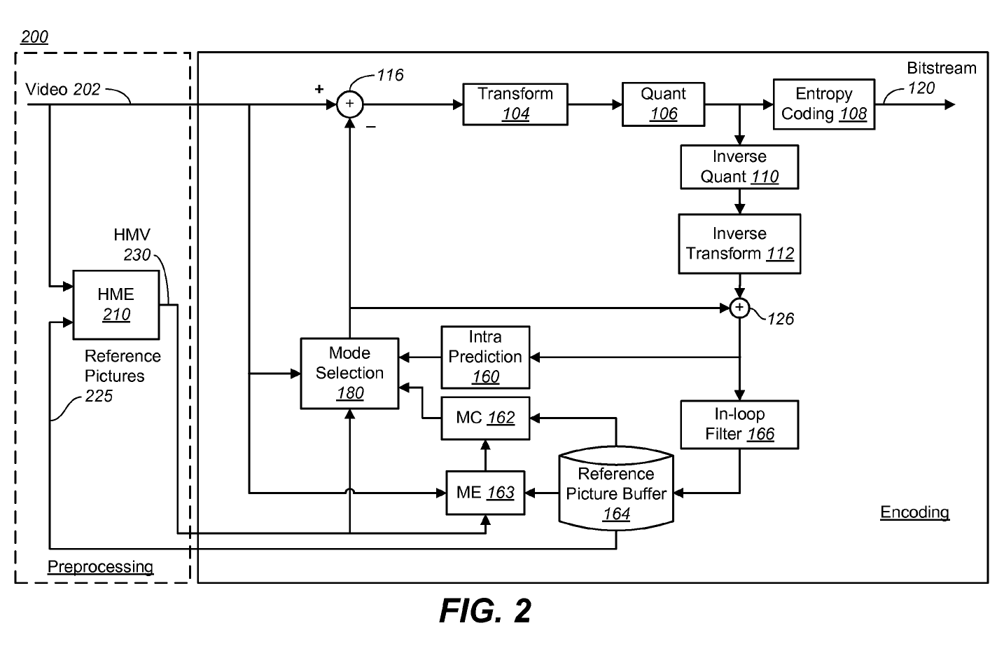

FIG. 2 shows a block diagram of an embodiment of a video coding system that utilizes hierarchical motion estimation (HME) as an initial step for motion analysis. The video coding system can be, for instance, a block-based video coding system. Such an initial step can be utilized to provide hint information for approximating motion information for subsequent motion analysis, motion related video applications, and other fast motion estimation methods such as an Enhanced Predictive Zonal Search (EPZS) [reference 4, incorporated by reference in its entirety].

The term “hint information” is used herein to describe such advice, clue, and/or approximation of the motion information generated by the HME method for any subsequent analysis. It is noted that HME [reference 5, incorporated by reference in its entirety] may also be used for video coding directly as the motion estimation (163).

In addition or alternatively to standard motion estimation in video coding, the HME method may be executed by utilizing EPZS at each h-layer. The HME can provide a variety of relevant information in spatial and temporal domains, which may be used as hint information for targeting calculations that apply to other applications or modules that utilize temporal correlation information in video encoding systems. By way of example and not of limitation, hint information may be utilized in, for instance, reference data reordering, fast reference data selection, the use and derivation of weighted prediction information, and/or mode decisions for more optimized or faster calculations or selections. The combination of HME with a fast motion estimation method may offer faster motion estimation than a full motion search incorporating, for instance, a spiral search or a raster scan approach of all possible positions.

The present disclosure describes methods for hierarchical motion estimation (HME) and applications of these HME methods to provide hint information for approximating motion information for subsequent motion analysis and fast video encoding. For example, for pre/post processing the HME methods provide information that may be used for the derivation of the weighting parameters used to combine motion compensated temporal filtering (MCTF) signals. Such weighting parameters can be derived by determining the quality of the MCTF signals as a prediction before combining the MCTF signals. One may use relative distortion as well as distance of a reference from a current portion of the video data to derive said weighting parameters. For example, regions with lower distortion may utilize a stronger weight than regions with higher distortion.

As another example, for each portion of the input video data, MCTF may be applied, comprising applying motion estimation (163) on the portion of input video data to derive relationships between adjacent portions (e.g., pictures or blocks) of the input video data. One may define such related blocks between different parts of the input video data in MCTF as involving motion estimation using multiple references, commonly several references (e.g., M) in the past and additionally (although optionally) several references (e.g., N) in the future. These references may have been previously preprocessed. Motion estimation for the current portion of the input video data involves searching some or all of these references (at the block or region level) and combining the hypotheses derived from these searches to create a final filtered signal. More details regarding MCTF can be found in [reference 7, incorporated by reference in its entirety].

In the application of MCTF, the related portions of the input video data may be averaged with or without weighting factors and filtered to remove noise. Spatial filtering with a loop filter (166) may be applied on either or both of reference data and current input data. In addition, spatial filtering may be applied before applying motion compensation (162) or before motion estimation (163). Decisions for the weighting can be determined based on spatio-temporal analysis, including distortion and motion vector values.

Motion estimation (ME) in H.264 can be more complex than in other prior standards such as MPEG-1, MPEG-2, or MPEG-4 Part2 at least due to multiple reference pictures as well as multiple prediction modes being allowed in H.264, as compared with using only a single reference picture in the aforementioned prior standards. In addition to temporal predictions and the MCTF application described above, motion estimation (including hierarchical motion estimation methods described in the present disclosure) can also be used in other motion related video applications such as deinterlacing, denoising, super-resolution, object tracking, and depth estimation.

For example, motion compensated interpolation based on motion information between different existing fields has been utilized to predict missing frame samples for deinterlacing. The HME can provide high quality motion information for such prediction. Further, application of HME for denoising may provide several additional features as compared with conventional motion estimation. The first is that HME may be robust to noise and can provide accurate motion information. The second is that application of motion estimation and denoising can be iterative from layer to layer. For example, initial motion information derived from an upper layer can be used first for denoising, and then refinement of motion information can be carried out based on denoised data (e.g., a denoised picture). Iterative refinement of motion information may yield more accurate motion information.

For another example, in HME based super-resolution, an upper layer high resolution image can also be considered in a fusing process. Yet further, in an HME-based object tracking application, computational complexity can be reduced from conventional processing due to layered processing. Specifically, the search range can be much smaller in lower resolution and refinement will only be carried out in a higher resolution.

FIG. 2 shows a diagram of an exemplary video coding system (200) utilizing HME (210) as an initial step for motion analysis. Such an initial step involves preprocessing of an input video signal (202) prior to encoding of the input video signal (202). The input video signal (202) may comprise input video regions. Intra prediction (160) and/or motion estimation (163) and motion compensation (162) may be applied on each region in a reference picture (225) from a reference picture buffer (164) to generate a prediction region, where whether intra prediction (160) or motion estimation (163) and motion compensation (162) (or neither) is applied is selected by a mode selection and control logic unit (180) to generate a prediction region.

The hierarchical motion estimation (HME) unit (210) of the video coding system of FIG. 2 may also receive the video input regions, which may be used with reference pictures (225) from the reference picture buffer (164) to generate hierarchical motion vector information (HMV) (230). The hierarchical motion prediction (230) may be used with the video input regions by the motion estimation unit (163) and the motion compensation unit (162) as selected by the mode selection and control logic (180) to generate the prediction region.

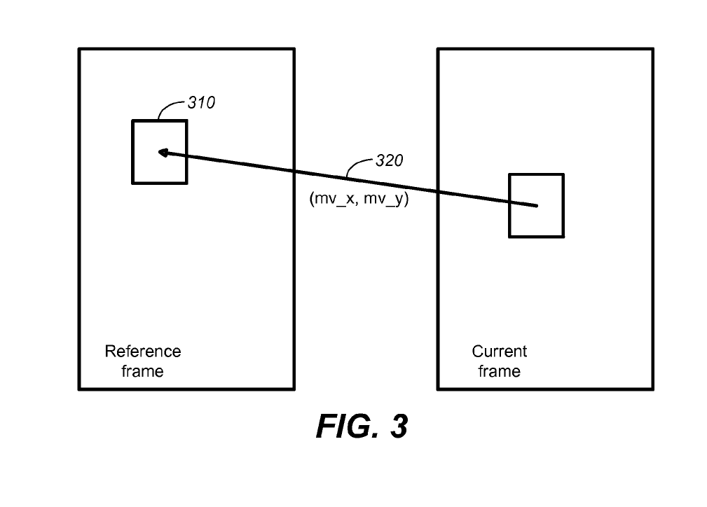

FIG. 3 shows an example of block-based (310) motion prediction with a motion vector (320) (mv_x, mv_y) with a translational motion model. It should be noted that other motion models such as affine, perspective, parabolic, and so forth that involve parameters such as zoom, rotation, skew, and so forth can be utilized in motion prediction. Motion models can also be combined with derivation of weighting parameters (such as due to illumination changes). Methods and systems for calculating or deriving weighted parameters are described in more detail in PCT Application with Serial No. PCT/US2012/060826, for “Weighted Predictions Based on Motion Information”, Applicants' Docket No. D11032WO01, filed on Oct. 18, 2012. The weighted prediction (WP) parameters can also be derived in a layered processing manner by utilizing HME architecture. In each h-layer, the best WP parameters for each region can be calculated by means of, for example, least square estimation method or direct current (DC) removal, and some of those WP parameters, especially those associated with lower distortions, can be accumulated at a next h-layer. All WP parameters may also be passed from a lower h-layer to the next h-layer. At the last h-layer, the system may make the final decision to select those WP parameters associated with minimal distortion for encoding. In some cases, such as for pre- or post-processing, all WP parameters may also be retained. Specifically, HME can be utilized for each block in each h-layer utilizing each reference picture in order to obtain motion vectors as well as weighting parameters and offset parameters given, for instance, distortion and/or rate-distortion criteria. Generally, the HME process is utilized to obtain motion vectors and parameters associated with minimum distortion (and/or minimum rate-distortion). These parameters can be refined with information from other h-layers.

The present disclosure describes motion vector (MV) prediction in HME, HME based fast motion search, and how HME information can be utilized. In video coding, HME information can be utilized in fast partition selection and reference picture selection. In motion compensated video filtering, HME motion information can be utilized to reduce noise, perform de-interlacing or scaling (e.g., super-resolution image generation), and frame rate conversion, among others. In addition, HME information may be utilized to derive weighting parameters for filtering signals for pre/post-processing of image information.

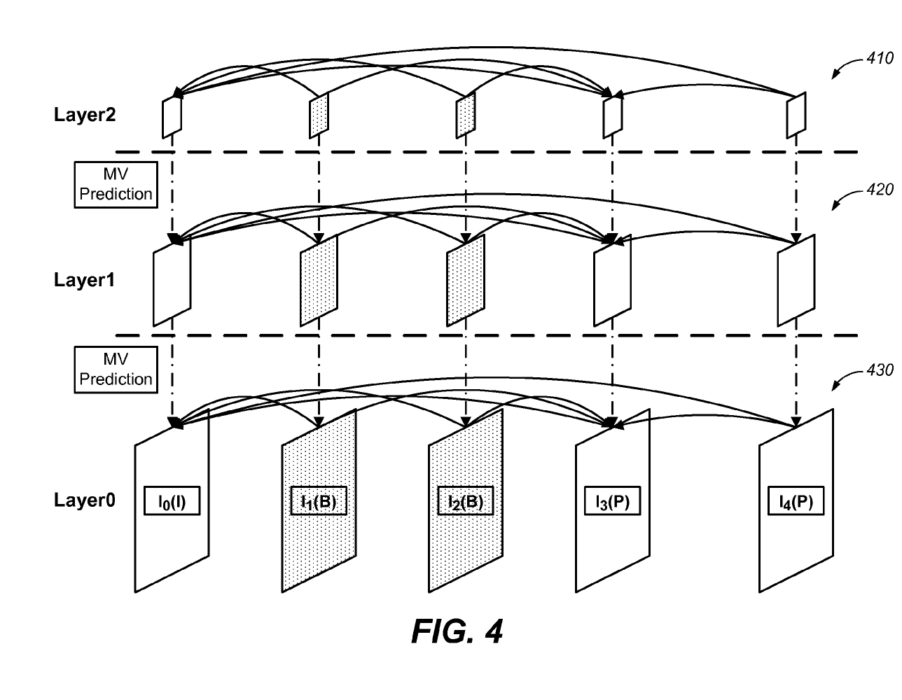

FIG. 4 shows an exemplary hierarchical motion estimation structure for HME. The HME may be utilized to apply a layered motion search or motion estimation (ME) on various down-sampled versions of an input video picture, starting with a lowest resolution (410) and progressing on with the same resolution with different sampling filter or higher resolutions (420), until an original resolution (430) is reached. An uppermost or highest h-layer is associated with the lowest resolution (410) while a bottommost or lowest h-layer is associated with the highest resolution (430).

In general, in a case where a first h-layer is associated with a lower resolution than a second h-layer, the first h-layer is referred to as being a higher h-layer than the second h-layer. The current disclosure follows this convention and refers to the lower resolution h-layers in HME as higher h-layers. There is no limitation for scaling factor among those h-layers, and the scaling factor between h-layers need not be constant. The down-sampling or up-sampling method utilized for each h-layer need not be the same.

For example, one may wish to scale from a lower resolution to a higher resolution, back to a lower resolution (not necessarily the same as the previous resolution) h-layer. Such methods may be useful where the higher resolution information may provide some additional refinement information, or applying a smaller search range refinement, and then in the lower resolution applying weighted predictions or extending the search range. The utilization of weighted predictions or extension of the search range may use information from neighboring partitions in the higher resolution to improve performance. Other methods for choosing up-sampling or down-sampling can be related to the reference frames and how those are examined.

FIG. 4 also shows five pictures I₀-I₄ for h-layer 0, which is the highest resolution h-layer or original resolution h-layer (430). The list of pictures I₀-I₄ denotes a sequence of pictures in time with a fixed time interval between each picture and a subsequent picture. Each picture can be a reference picture or a non-reference picture.

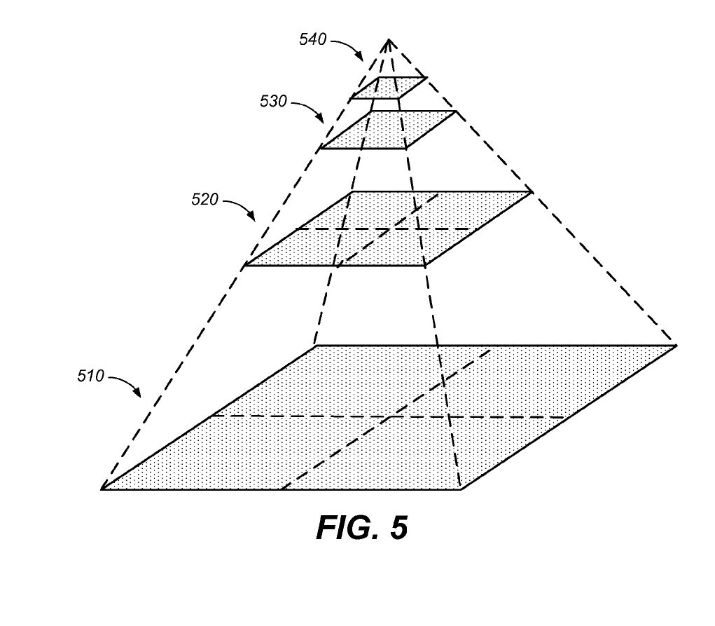

FIG. 5 provides a diagram showing another exemplary HME structure with four h-layers and a scaling factor of 2 in each of the x and y dimensions between h-layers for an input video picture. As mentioned before, the scaling factor can be greater, equal, or less than 1 and may be different or the same for each h-layer. For sampling, a low-pass filter used for down sampling or denoising can be varied with different applications. The low-pass filter generally removes details while reducing the noise. The sampling filter is selected, for example, by evaluating trade-offs between details and anti-aliasing according to applications. For video coding, filters that retain more details are often preferred. To reduce the removal of details, a low-pass filter with a fewer number of taps (e.g., 2 or 3) may be utilized in hierarchical image generation. Exemplary filters that can be utilized for HME include the [1 2 1]/4, [1 6 1]/8 and [1 1]/2 filters for dyadic sampling. Bi-cubic and DCT based sampling filters can also be used.

An upper h-layer image can be derived from a neighboring lower h-layer. With hierarchical image generation, the noise can be reduced even with weak low-pass filters because there are more h-layers. The hierarchical motion estimation may comprise applying motion estimation (ME) starting from an uppermost or highest h-layer (540) to a bottommost or lowest h-layer (510), where the uppermost h-layer (540) has the lowest sample rate or resolution of ⅛ of the original resolution in each dimension, a second h-layer (530) has a sample rate of ¼ of the original resolution in each dimension, a third h-layer (520) has a sample rate of ½ of the original resolution in each dimension and the bottommost h-layer (510) has the original resolution (also referred to as full resolution).

As previously noted, although FIG. 5 shows a constant scaling factor of 2 in each of the x and y dimensions between adjacent h-layers, the scaling factor in each of the x and y dimensions between h-layers need not be constant. Further, scaling factor for each dimension in an h-layer need not be the same. For example, the scaling factor in the x dimension does not have to be the same as in the y dimension.

HME's layered structure may return a more regularized motion field with more reliable motion information compared to applying motion search directly on the original picture. One reason is that the down-sampling process with a low-pass filter may help with removing or reducing noise in the original picture. It is noted here that the references for the HME may be either original pictures or the pictures that were previously encoded (or filtered/processed). Also note that if the reference pictures were previously filtered/encoded, the decimation process (filtering+down-sampling) helps in increasing correlation with the original current picture versus applying motion estimation in the original resolution. For pre/post processing, the filtered pictures may have been pre-processed before decimation by using, for instance, a spatial filter, but may also have included prior MCTF (spatial and temporal) processing.

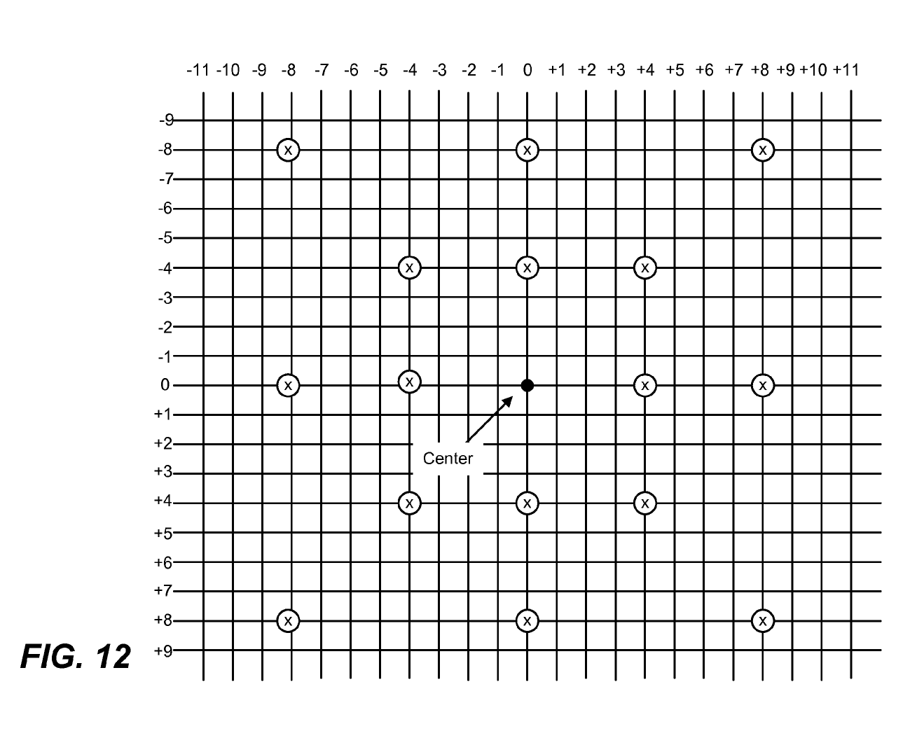

Another reason is that the block size for motion estimation at each h-layer may be the same (for example, 8×8 block size). However, it is noted that different block sizes can be present in the same h-layer. As shown in FIG. 11, the motion field of HME at the h-layer-0 (1110) is initialized with the MV scaled from h-layer-1 (1120) and is further refined within a small search window.

The exemplary application of HME considers at each h-layer (h-layer-1 (1120) in the example shown in FIG. 11) blocks that are of a certain larger partition size, which are later subdivided to a smaller partition size when moving to the next h-layer (1110). This means that before subdivision, motion for multiple adjacent partitions was estimated but as a single group/partition. The refinement at the next h-layer (1110) is commonly constrained around a smaller search window, making the search more correlated. The derived MV predictor can be generated with any existing predictors by means of, for example, some mathematic operation such as median filtering or weighted average.

Predictors such as temporal and/or inter-layer predictors may be associated with each partition in h-layer-1 (1120). Subsequent to obtaining such predictors, a filter, such as a median filter, may be utilized to derive predictors from these existing predictors. Similarly, predictors from h-layer-1 (1120) can be utilized to generate predictors in the next layer h-layer (1110). In FIG. 11, scaling from h-layer-1 (1120) to the next h-layer (1110) generates inter-layer predictors in the next h-layer (1110) for each predictor in h-layer-1 (1120). These predictors, including neighboring blocks' predictors associated with each partition in the next h-layer (1110), can then be filtered by, for example, a median filter, to derive one predictor for each partition.

The motion information from the HME can be used directly as the motion estimation with either no further refinement during subsequent MB (macroblocks) coding loop and beyond the HME results or additional motion estimation refinement can be based on the HME motion information at the MB coding level. The HME motion information may also be used to assist in or as part of the motion estimation and mode decision processes during the encoding process, for example, by improving coding efficiency by optionally driving the MB level motion estimation. Further coding efficiency may also come from the fact that HME schemes can cover a broader range of motion vectors much faster (due to the possible reduced resolution) and thus may better deal with larger resolutions and high motion than other techniques.

There are many kinds of MV predictors that may be evaluated as part of the HME. The kinds of MV predictors may include intra-layer MV predictors, inter-layer MV predictors, temporal MV predictors, fixed MV predictors, and derived MV predictors. The utilization of the motion estimation scheme includes generating and evaluating MV predictors, and setting the center of one or more search windows at the ordered MV predictors, which are ordered based on the calculated error. For instance, the MV predictors may be ordered in increasing order compared to their distance from a predictor, e.g., (0,0), a median predictor, or a co-located hierarchical predictor.

By way of example and not of limitation, the error can be an objective error metric such as a rate-distortion cost using the sum of absolute or square differences for the distortion computation whereas for rate an estimate of the bit cost can be made given the relationship of the tested motion vector versus its neighboring motion vectors. Other, generally more complex metrics that try to better mimic the human visual system and may have more subjective visual quality targets, such as, among others the structural similarity (SSIM) index, can be used. This evaluation of the MV predictors to find a most accurate predictor can make motion estimation processes faster and/or more accurate.

It should also be noted that more than one metric can be calculated in order to evaluate the MV predictors. For example, a sum of absolute differences (SAD) can be computed as one metric for a region while a rate-distortion cost can be computed as another metric for the same region. As another example, a sum of absolute differences (SAD) can be computed as one metric for a region and a structural similarity (SSIM) index can be computed as another metric for the same region. Other combinations of two or more metrics can be utilized. Such metrics can be combined or considered in isolation. As used in this disclosure, the term “metric” or “error metric” can refer to a metric (e.g., SAD, SSIM) considered in isolation or a combination of two or more different metrics.

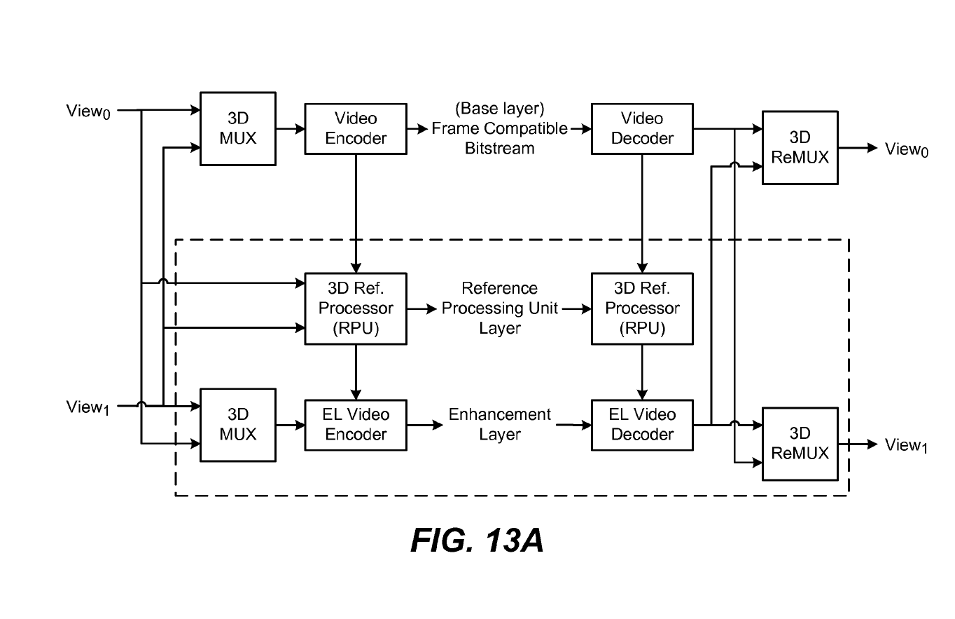

FIG. 12 shows an example of fixed predictor locations based on and relative to a derived center location. One or more derived MV predictors can also be generated with any existing predictors by means of, for example, some mathematic operation such as median filtering or weighted average. Further, statistical predictors could also be adjusted/introduced given prior results (e.g., if prior results suggest that an MV is near the center, the HME could adjust/generate a new set of predictors around that area statistically). The intra-layer MV predictors are also known as spatial MV predictors. The intra-layer MV predictors are the MVs of neighboring blocks for which motion estimation has been completed within the same h-layer, for example in a raster scan pattern, which can then be used for predicting the current block of interest.

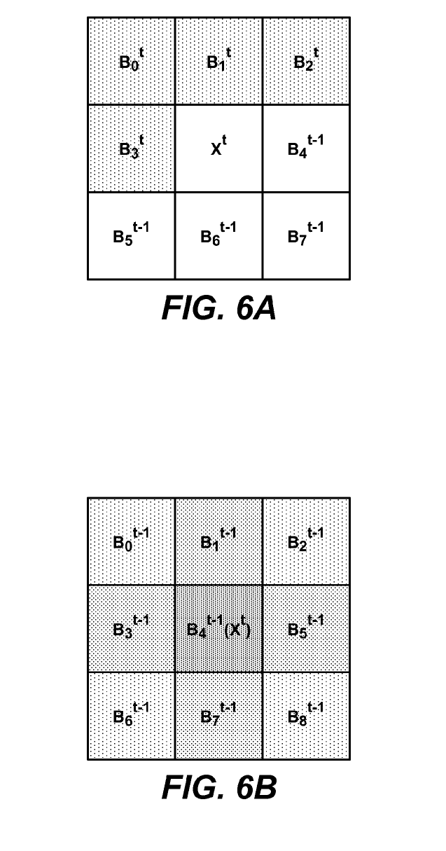

FIG. 6A shows a diagram illustrating an example of intra-layer MV predictors. A set of nine regions are shown to be at a particular stage of motion prediction where the regions B₀^{t}, B₁^{t}, B₂^{t}, and B₃^{t} (shaded with dots) have already completed motion estimation for the current h-layer with time t and thus these regions have calculated MV available whereas the center region, which is a current region of interest, as indicated with X^{t} has not completed motion estimation. The regions B₄^{t-1}, B₅^{t-1}, B₆^{t-1}, and B₇^{t-1} also have not completed motion estimation for the current h-layer with time t and are indicated with the time t−1 of a previous h-layer.

It is noted that even though this example shows h-layer with temporal order, or temporal references, this is by no means the only order or reference available for the h-layers. The h-layer at t−1 (or any t−n) can come from any previously encoded reference and not necessarily just a prior temporal reference. The variable “t” can denote any ordering and not just temporal ordering.

Motion estimation for the current region can utilize as intra-layer MV predictors a motion vector from each of the regions B₀^{t}, B₁^{t}, B₂^{t}, and B₃^{t} (shaded with dots) for the current h-layer. In a case of multiple MV predictors, methods such as median filtering may be applied to obtain a more accurate predictor from multiple candidates.

FIG. 6B shows a diagram illustrating examples of inter-layer MV predictors. A current h-layer, as indicated by the superscript “t”, of the HME can refer to motion information from a previous h-layer, as indicated by the superscript “t−1”, which has completed motion estimation, as predictors because the application of motion estimation process is in order from upper to lower h-layers. Therefore, motion estimation has been completed for an upper h-layer prior to the application of motion estimation in a lower h-layer and thus the motion information for the upper h-layer in the HME searching order can provide initial motion information for use in the lower h-layer under consideration.

Equation (1) illustrates an exemplary mapping method from h-layer (n+1) (Lₙ₊₁) to the h-layer n (Lₙ) for generating inter-layer predictors.

MV(bₓ,b_{y},refₖ,Lₙ)=MV(bₓ/sf,b_{y}/sf,refₖ,Lₙ₊₁)×sf (1)

where bₓ, b_{y} are positions of a region or block in a picture, sf is a scale factor between h-layer (n+1) and h-layer n, and refₖ is a k-th reference picture. It should be noted that a motion vector is indexed by its reference to a position bₓ, b_{y} in a picture; a specific reference picture refₖ; and an h-layer Lₙ. In cases where reference pictures are stored in multiple lists, the motion vector is further indexed by the number of the list (e.g., LIST_{—}0 and LIST_{—}1).

In FIG. 6B, in generating motion vectors for a current region X^{t}, motion information from regions of a higher h-layer or h-layers can be utilized. Nearest regions from the higher h-layer or h-layers in adjacent neighboring regions (e.g., B₁^{t-1}, B₃^{t-1}, B₅^{t-1}, and B₇^{t-1}) can be utilized to generate motion vectors for the current region or block X^{t}. Similarly, regions from the higher h-layer or h-layers in farther neighboring regions (e.g. B₀^{t-1}, B₂^{t-1}, B₆^{t-1} and B₈^{t-1}) can also be utilized in generating motion vectors for the current region or block X^{t}.

A co-located region from a higher h-layer or h-layers can be utilized to generate motion vectors for the current region or block X^{t}. The mapping motion vector of region X^{t} may be from the motion vector of the same region at a different h-layer as indicated by B₄^{t-1}. This particular predictor is referred to as an inter-layer predictor. Systematic removal of predictors may also be applied. For example, in the case of multiple predictors, a median filter can be used to remove outliers and reduce the number of predictors. Generation of predictors associated with subsequent h-layers may utilize a reduced set of predictors.

Another type of motion vector predictor is the temporal predictor. One example of the temporal predictor is shown in FIG. 4. The reference picture I₄ itself references reference pictures I₃ and I₀. In cases where there are multiple reference pictures, the HME process may search each reference picture in time sequence starting from the reference picture closest in time to the current picture, for example, for the HME at the lowest h-layer. Other variables may be used as basis for the order of search instead of time sequence. As another example, the order of search for subsequent h-layers could be based on distortion at that h-layer. Other criteria (like scene change detection) could also be applied as the variable used to determine the search order.

In the application of the motion estimation process for each h-layer of the picture I₄, each region can be searched for the two reference pictures I₃ and I₀. I₃ will be searched first since I₃ is closer in time to the current picture I₄ than I₀ as shown in FIG. 4. The motion vector information of I₃ can serve as a motion vector predictor for I₀ using scaling according to the temporal distance between I₄ and I₃ or I₄ and I₀ respectively. Equation (2) shows an example of how such temporal distance scaling can be incorporated.

MV(bₓ,b_{y},refᵢ,Lₙ)=MV(bₓ,b_{y},refⱼ,Lₙ₊₁)×TD(i)/TD(j) (2)

where TD(i) and TD(j) are the temporal distances between the current picture and reference pictures i and j respectively. With reference specifically to FIG. 4, assume that the current picture is I₄ and has a temporal distance TD(I₀)=4t from I₀ and a temporal distance TD(I₃)=1t from I₃, where t is the constant time scale between each picture and the subsequent picture. Consequently, TD(I₀)/TD(I₃) equals 4 in such a case.

The search framework for applying HME can comprise multiple loops for applying motion estimation, since motion estimation is applied for each region or block of each h-layer utilizing each reference picture from one or more reference picture lists. The order of application of motion estimation or motion estimation process for HME through each of these variables (region/block, h-layer, and reference pictures) may be chosen, for example, for optimizing speed and accuracy of the motion estimation.

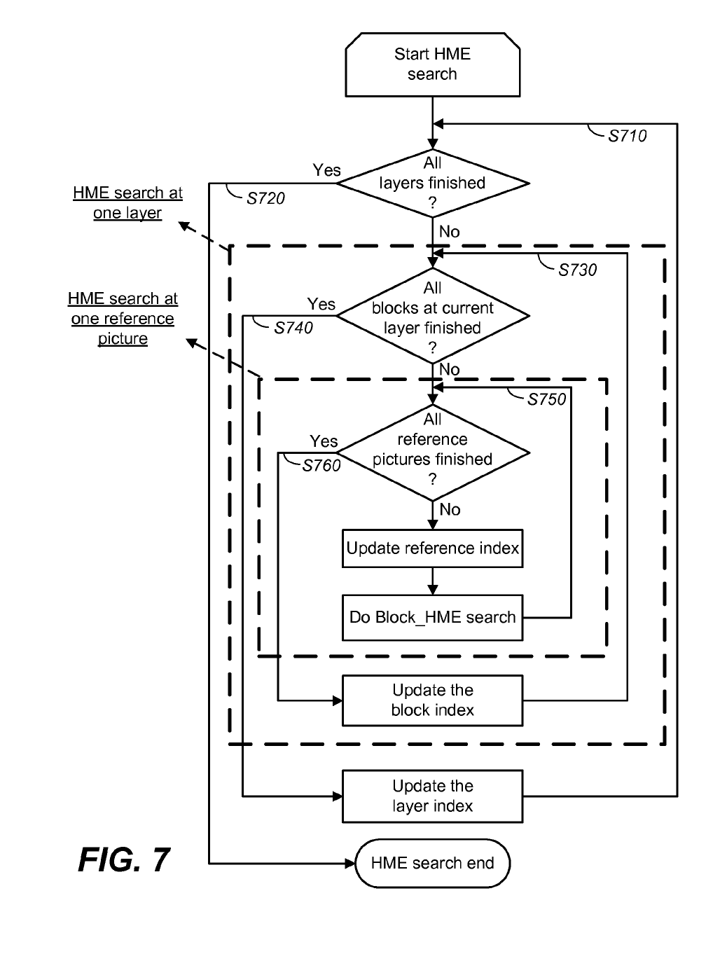

FIG. 7 shows an embodiment of an HME search comprising three concentric loops: a reference picture loop (S750, S760), a block loop (S730, S740), and an h-layer loop (S710, S720). Specifically, FIG. 7 shows the reference picture loop (S750, S760) as the inner-most nested loop, the block loop (S730, S740) as the next nested loop, and the h-layer loop (S710, S720) as the outer loop. In some cases, this computational ordering can benefit from the temporal predictor being available and the memory access being more efficient because the motion estimation of all blocks at one h-layer is applied within one reference picture. Other computational orderings (such as exchanging the order of nested loops or computing in an order without loops or without well-defined loops) can also be implemented. Furthermore, the example in FIG. 7 assumes a single reference list, but an additional loop can be added for multiple reference lists to make available, for instance, bi-prediction. For a bi-prediction search, the HME can be applied on each single list first. Then the bi-prediction search may refine the MV from one list first while fixing the MV from another single list. By way of example, the process can be iterative until the error is lower than the set threshold, until the process reaches a predefined number of repetitions, or until no further change in the motion search is perceived.

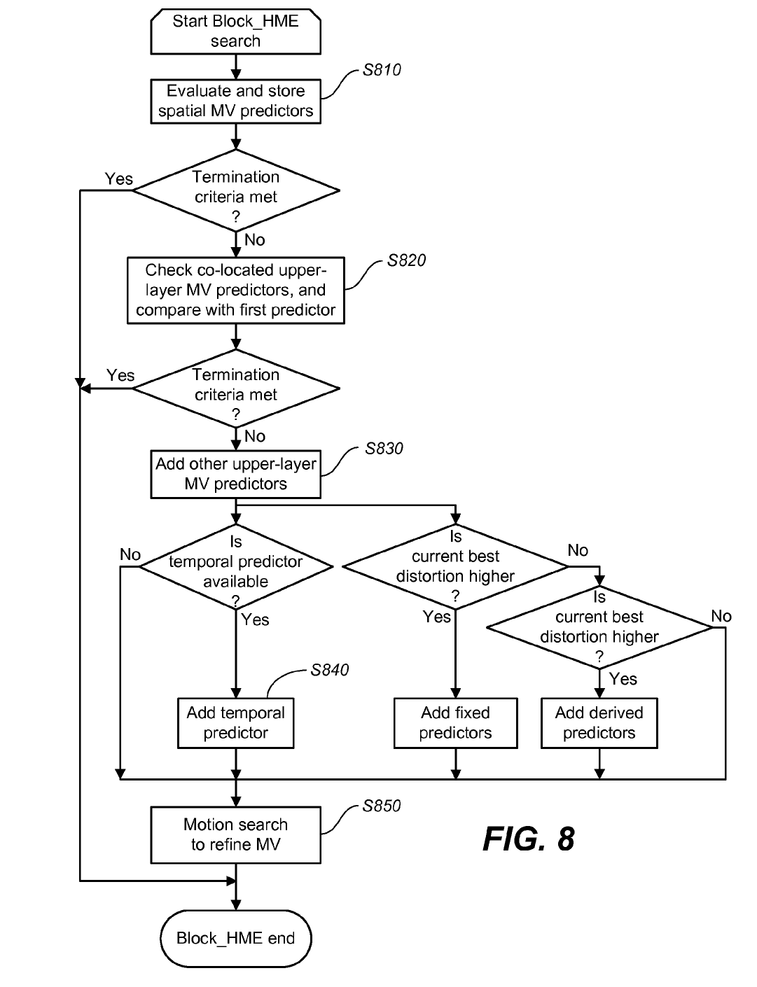

A first loop (S750, S760) is the reference picture loop, where motion estimation is applied utilizing each reference picture for each block in each h-layer. In a specific iteration of the first loop (S750, S760), the block and the h-layer is fixed (referred to as current block and current h-layer, respectively) while each reference picture is applied to the current block of the current h-layer. For each reference picture for which motion estimation has not been applied, the reference index can be updated and the block-level HME, as shown in more detail in FIG. 8, is applied in a step S750.

It is noted here that the block-level HME is applied at a selected block size. Block sizes may vary from h-layer to h-layer or be fixed from h-layer to h-layer. Upon the completion of the block-level HME S750, the first loop (S750, S760) or the reference picture loop looks for another reference picture with which motion estimation has not been applied. The first loop (S750, S760) continues until the reference pictures in each list have been used for the motion estimation of the current block for the current h-layer, or until an early termination condition is satisfied. At the end of each h-layer motion estimation, uncorrelated reference pictures based on distortion of motion estimation can be removed for subsequent h-layers.

For example, for a h-layer N, if it is determined that a particular reference K is irrelevant (e.g., a reference associated with a different scene) or low in relevance in terms of distortion versus other references, the particular reference K can be removed when applying motion estimation for a different h-layer N+1 and/or for subsequent refinement of the current h-layer N. Inversely, for example, a lowest resolution h-layer may consider only a first reference, and then the number of references (e.g., at the region level) can increase at higher resolution h-layers.

Motion vectors for additional references beyond the first reference can be predicted by scaling the motion vectors associated with the first reference. As another example, the reference can be subsampled and then interpolated during refinement of motion vectors given motion vectors of a subsampled reference space associated with other references.

It is also noted that an example of number of references is 16 and that these references may be “virtual references” and may include the same reference picture replicated (e.g., maybe with different weighted prediction parameters). The list of reference pictures may be different from one codec to another. In addition, an adaptation of the number of references may be included, depending also on the h-layer level, single-list or bi-prediction, and other variables in the motion estimation.

The application of motion estimation for each block of each h-layer with each reference picture may generate a single motion vector for the block given all references, or a motion vector for each reference. Motion information resulting from the application of motion estimation with one reference picture can be used as predictors for other references. Predictors may be adjusted based on already generated predictors in the HME, e.g., earlier completed loops. In addition, adjustments of thresholds and search patterns may be made based on HME predictors already generated. In particular, an adaptation of the h-layer motion estimation parameters may be made based on information generated within each h-layer from checking one or more of the blocks and one or more of the references.

Upon completion of motion estimation in the first loop (S750, S760) in a step S760, a second loop (S730, S740) or the block loop is entered. In the second loop (S730, S740), the block index is updated in a step S730 to a next block yet to have motion estimation applied for the current h-layer. The application of the HME then returns to the first loop (S750, S760) to complete motion estimation for the new current block utilizing each reference picture until, again, all reference pictures have been used in the application of motion estimation for the new current block in the current h-layer.

Upon completion of motion estimation in the first loop (S760, S750) again in a step S760 for the new current block, the second loop (S730, S740) is again entered to update the block index. Once motion estimation utilizing all reference pictures has been performed for each block in the current h-layer, the third loop (S710, S720) or h-layer loop is entered. The h-layer index is updated in a step S710 of the third loop (S710, S720) to the next h-layer awaiting the application of motion estimation. For the next h-layer, motion estimation is applied for each block (second loop (S730, S740)) in the next h-layer using each reference picture (first loop (S750, S760)).

The HME ends at the completion of motion estimation for all h-layers from a lower resolution (e.g., upper h-layers) to a higher resolution (e.g., lower h-layers) in a step S720, where motion estimation has been applied to all of the blocks of each h-layer utilizing all of the reference pictures. It should be noted that the motion estimation as shown in the three loops (S710, S720, S730, S740, S750, S760) of FIG. 7 can be applied to video signals comprising blocks, h-layers, and reference pictures in any order of these three variables or another set of three or more variables, and that FIG. 7 only provides an exemplary ordering.

FIG. 8 shows a region-level HME search flowchart for a particular h-layer and a particular reference picture noted as “Block_HME search”. For faster application of the HME process for the region-level HME search, evaluation of spatial motion vector predictors, in a step S810, at the same h-layer can be conducted prior to evaluation of predictors associated with other h-layers since spatial MV predictors generally provide more accurate predictors compared to other predictors (e.g., inter-layer and temporal predictors). The MV predictors can also be stored in the step S810 for further motion estimation refinement, for example an EPZS search.

During the evaluation of the spatial MV predictors in the motion estimation, if the error (for example as calculated by one or more objective or subjective metric such as rate-distortion or SSIM index) evaluated for the spatial motion vector predictor is lower than one or more set termination criteria, the spatial motion vector predictor is selected and the motion estimation process for the current region at the current h-layer can be terminated without further search.

The set termination criteria can be an adaptively set based on errors associated with other motion vector predictors, distortion of neighboring blocks, or distortion from previous h-layers (for example, at the co-located position). One may consider the relationship of a co-located block to its neighborhood, and use the resulting information to project or predict distortion behavior pattern for the current block. For example, the resulting information can be used to refine or adjust thresholding parameters for the current block.

As another example, if the set termination criteria are not met after evaluation of the spatial predictor at the same h-layer for the current bock at the current h-layer, the region level HME search can incorporate evaluation of the co-located inter-layer predictor in a step S820. The set termination criteria can again be evaluated with the co-located inter-layer predictor and the evaluated predictors may be ordered according to each predictor's error for center determination of refinement search window. It is noted here that the set termination criteria itself could also be adapted based on a distortion value from the spatial predictor and also a value of the inter-layer predictor and not necessarily in that order, as the order may be adaptive based also on the characteristics of the video picture content.

As an example, one may initially conduct a spatial analysis or examine how values at co-located regions may have been changed from one h-layer to the next. Another exemplary criterion for consideration includes a value of the motion vectors (e.g., if all motion vectors are exactly zero, or maybe even close to zero, this suggests stationary status). In the case of stationary status, the inter-layer predictor may be better than spatial predictors at finding object boundaries or, if both are equal, a higher confidence can be reached and thresholds may be tuned more precisely. Distortion of neighboring blocks and distortion from co-located partitions can also be utilized in adapting the set termination criteria.

If the termination criteria are not met utilizing the spatial predictors and the co-located inter-layer predictors, then other inter-layer predictors can be evaluated in motion estimation and stored in a step S830, after which temporal predictors can also be evaluated and stored (step S840) if the termination criteria has not been previously met. Fixed predictors and derived predictors may also be evaluated in motion estimation and stored if the termination criteria have not been previously met. All of these predictors are generated with the same reference picture as the current reference picture loop as shown by S750 and S760 in FIG. 7. These predictors may be skipped or may be treated separately.

The above described method for reaching termination criteria is an exemplary method for conducting the HME and is meant to be descriptive of the process and not limiting. Other methods or sequences may be utilized. Additional steps may be included in the method. For example, inter-layer predictors can also be correlated first with temporal predictors before testing for the termination criteria. Further, it is possible to find multiple predictors of the same value and these predictors may be ordered with a probability model.

If multiple predictors of the same value are found in adjacent partitions, the multiple predictors may be given a higher probability than other predictors. Also to be considered can be that predictors from an inter-layer may need to be scaled given the different resolution used across the h-layers. Predictors could also be generated using information from other references. In the case where the motion estimation has been applied to a higher h-layer using reference A, the resulting motion information and distortion information may be used to improve the speed and/or accuracy of a subsequent motion estimation application utilizing reference B.

If the termination criteria are not met utilizing the available predictors, refinement of the available predictors may be applied via a motion search (S850). The motion search (S850) can be, by way of example and not of limitation, a fast search such as EPZS. Even in cases where some predictors meet the termination criteria, the motion search (S850) can still be applied to refine the available predictors.

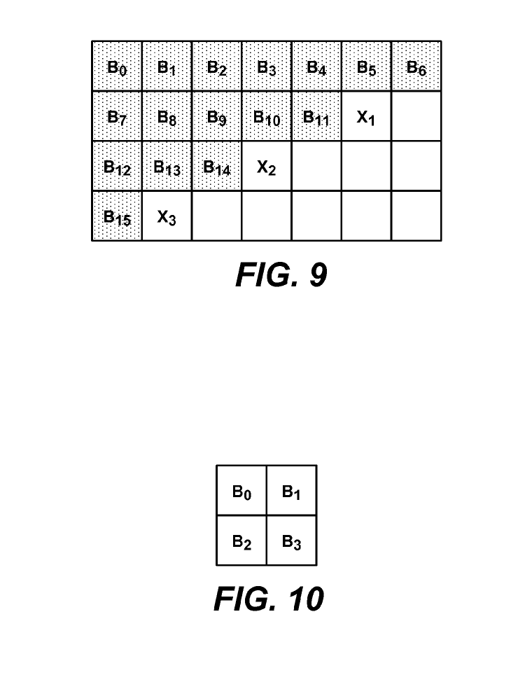

It is noted that multiple region HMEs can run in parallel. Therefore, the HME described in the current disclosure can facilitate parallel processing implementation of multiple blocks running multiple block loops (S730, S740) of FIG. 7 simultaneously. An example of multiple region HMEs running in parallel is shown in FIG. 9, the regions B₀-B₁₅ (shaded with dots) have already completed motion estimation and thus have calculated MVs available to be used as spatial MV predictors for regions X₁, X₂, and X₃. The MVs from regions B₄-B₆ and B₁₁ may serve as spatial MV predictors for region X₁, which can be processed simultaneously as region X₂ utilizing the MVs from regions B₉-B₁₁ and B₁₄ and so on. In the initialization of HME for each region, the center and search range of the search window for motion evaluation or the search of the MV are determined.

The fast refinement method can be also adaptively changed such that if the initial error is larger than a set threshold, then the conservative fast search method will be applied for safety. In one embodiment of the current disclosure, the center of the search window for motion estimation is initially determined by taking a mathematical median of some or all MV predictors stored.

In another embodiment of the current disclosure, the center of the MV search window is initially determined by the scaled co-located upper h-layer MV. To determine the center of the MV search window, one may use, as an example, the consistency, distance, and correlation between some or all predictors determined to be reliable. Reliability can be based on similarity, distortion, as well as on segmentation methods. The same may be used for the determination of the search range. In yet another embodiment of the current disclosure, the center of the motion estimation is initially determined by calculating a distortion associated with each available MV predictor and choosing the MV predictor which has the smallest associated distortion. The cost of the MV is denoted as J(MV) in equation (3).

Parallel processing of multiple regions can also be done by not enforcing consideration of spatial predictors. The image can be subdivided into partitions and spatial neighbors may be only considered within each partition rather than for the whole picture. As yet another example, one may only consider of spatial neighbors that have completed motion estimation.

The computation of the median for the spatial MV predictors can be conducted within the reference picture loop (S760, S750) using neighboring motion information of the same reference picture for current block. Further refinement of the MV predictor can also be done, and may be typically done for h-layer 0. For example, integer resolution MV can be calculated by the motion estimation at upper h-layers while h-layer 0 may in addition calculate fractional resolution MV for a better estimation.

This further refinement can be added to the neighboring motion information to find the best MV associated with its reference picture in terms of lowest distortion cost for each block. The median of the spatial neighbor MV predictors from the same reference picture may be a lowest cost neighboring MV predictor, which might have different reference picture than the current reference picture loop. Further, the median could be a scaled motion vector based on reference indices (or reference distances).

A fast searching method applied in this stage may be the simple version of Enhanced Predictive Zonal Search (EPZS) method [reference 4] or other search methods. In EPZS, the accuracy of predictors may affect the speed of the motion vector search in motion estimation. The region level HME of the current disclosure is capable of being fast at least because it exploits the efficiency of prediction in intra-layer, inter-layer, and temporal aspects. Full search (FS) could also be used during the HME refinement for all or some h-layers. A hybrid scheme that uses FS and EPZS for example could also be used (e.g., FS at lower h-layers and moving to EPZS at higher h-layers). Furthermore, subsampling or bit depth reduction could also be considered, for example, at lower levels. It is noted that subsampling or bit depth reduction may not be as effective at higher levels where accuracy is more important than at lower levels.

At the searching stage for HME, fixed block-size may be used to reduce the complexity. However, block-size can be different for each h-layer. There may be multiple partitions with different block-size (16×16, 16×8, 8×16, 8×8, 8×4, 4×8, 4×4) in H.264 encoding for each macroblock. Such motion information may be refined at the encoding stage.

HME may be utilized for the motion estimation process at the encoding stage in an embodiment of the present disclosure. HME may provide for all motion information estimated around the current block to be encoded. The motion vector information may be reused subsequently as additional predictors for the motion estimation processes (163). The motion vector information can also be used as the center of search window or the derivation of the search window.

With more accurate MV predictors, the motion estimation process may be more efficient because the search starts with a better matched region. For example, if EPZS [reference 4] is utilized as the motion estimation method, the MV derived in HME search may be reused as additional predictors for EPZS. For example, MV for a co-located block with same or different references or MV for neighboring block are all options for additional predictors for EPZS. This can be compared with the case without HME, where only MVs of left, top, top left and top right blocks are available as shown in FIG. 6A. In the case of EPZS fast motion estimation utilizing HME, all MVs of neighboring blocks including the current block itself are available. Thus the EPZS motion estimation utilizing HME will have more MV predictors to choose from, which may result in more accurate and robust MV predictors than without HME. In addition, the use of HME provided MV predictors can allow EPZS to use fewer predictors by removing less reliable predictors, e.g., by correlating them to the MV predictors from the HME, by testing how similar or far those may be, using simpler refinement patterns, using fewer refinement steps, and so on. The choice of number of predictors from HME to be used by EPZS can also be conducted in an adaptive manner based on the distortion, the MV values of different predictors, and termination criteria of the EPZS process.

In one embodiment of the current disclosure, the complexity of HME may be reduced by using reduced resolution MV only, such as integer pel only, or using reduced resolution MV for higher h-layer and higher resolution MV in h-layer 0. For example, integer pel may be used for h-layers larger than 0, while fractional pel may be used for h-layer 0. Since the purpose of HME is to give more accurate motion, the computed RD cost lambda as shown in equation (3) may be reduced.

J(MV)=D(MV)+λ×R(MV) (3)

where J(MV) is the rate distortion cost; Lagrangian cost or error for the MV; D is the distortion; and R(MV) is the rate, which relates to the number of bits needed to encode MV; and λ is the weighing factor applied to the rate for the rate cost or error calculation. The rate R can be either the true bit cost for the motion vectors or can be an estimate given some predefined method for estimating those bits. Examples of the distortion can include mean square error, sum of squared errors, sum of absolute error value or covariance, and sum of absolute transformed errors.

In an embodiment of the current disclosure, fixed block-size (8×8 for example) for HME has been used. For fixed block-sizes, sometimes the block size might be too small for higher resolution video, and the resulting motion vectors can become trapped into a local minimum or have difficulty finding a best MV for a difficult region. One way to reduce such effects is to set limits to MV scaling and clip the scaled MV within the maximum range and by clipping fixed predictors to avoid very big motion vectors

Another example of HME usage is to refine motion information based on HME results instead or in addition to applying motion search for all different block sizes in encoding. As an example, a set of MV candidates may be generated using HME results, and then those MV candidates may be tested and the best MV chosen as the one associated with minimum RD cost. In one embodiment, MV candidates may be generated for each block size in the following method. The set of MV candidates may contain:
Initial best MVs from HME for current block size
Spatial neighbor motion
HME h-layer 0 MV scaled from different reference indices other than the best MV
Spatial variation of best MVs, horizontal [−4, +4]×vertical [−1, +1] quarter pel. Those offsets of MV can also be scaled for different reference indices, which mean the offsets can be different for different reference pictures. The scaling can be based on the temporal difference between reference picture and current picture.

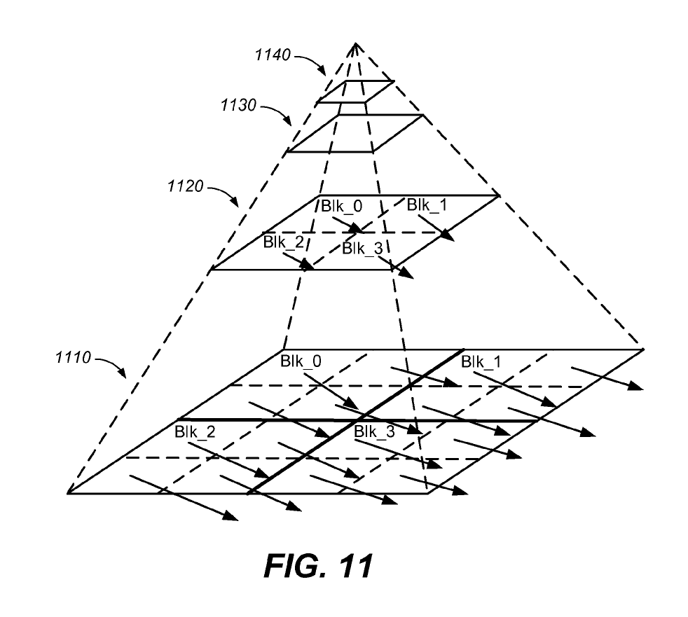

The distortion information of HME can also help partition selection and reference selection in H.264 video encoding, or other codecs such as the High Efficiency Video Coding (HEVC) codec. In H.264 encoding, each inter macroblock (MB) has 16×16 pixels and can have one of four possible partitions P16×16, P16×8, P8×16 and P8×8. An example MB consists of a P8×8 partition which consists of four 8×8 sub-partitions shown as B₀, B₁, B₂, and B₃ in FIG. 10. If the block size in the HME process is 8×8, this implies that one may derive the MV information of each 8×8 block. Then, one may exclude some partitions from the selection/mode decision process according to the distortion and MV information of each 8×8 block.

If the MVs derived from the HME process of all 8×8 sub-blocks within one partition (P16×16, P16×8, P8×16, or P8×8) of one MB have different MVs (for example, the maximum difference of MVs (MVD) is greater than the threshold), then this partition may not be the best one as it may have different motion information (e.g., motion vectors) between the different sub-blocks. Therefore one may determine the candidate partition mode according to HME MV information before final partition selection. The partition decision according to HME information can be accelerated at least because it may evaluate all possible partition modes determined by HME information with Rate Distortion Optimization (RDO) criteria, instead of checking all partition modes.

The reference selection may be based on each partition. The partition distortion of each reference can be estimated by Equation (4).

$$Distortion ( {ref}_{k} , P ) = {\sum }_{{B}_{i} ∈ P} HME\_Distortion ( {ref}_{k} , {B}_{i} ) \qquad ( 4 )$$

where P is the partition type and refₖ is the k-th reference picture. If the distortion for some reference picture is larger than a threshold scaled by a scaling factor α compared to the minimum distortion of all available reference pictures, then this reference picture is excluded from motion estimation. The threshold can be a function of Equation (4) above. For low complexity reference selection, the reference can be selected by the criteria of minimum distortion of HME. The threshold can be determined by the statistics from previous encoded partitions of the current slice and can be calculated as in Equation (5):

$${Th}_{ref} = α \cdot {min}_{k} ( Distortion ( {ref}_{k} , P ) ) \qquad ( 5 )$$

The methods and systems described in the present disclosure may be implemented in hardware, software, firmware, or combination thereof. Features described as blocks, modules, or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), or a field programmable logic array (FPGA)).

All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

The examples set forth above are provided to give those of ordinary skill in the art a complete disclosure and description of how to make and use the embodiments of the hierarchical motion estimation for video compression and motion analysis of the disclosure, and are not intended to limit the scope of what the inventors regard as their disclosure. Modifications of the above-described modes for carrying out the disclosure may be used by persons of skill in the video art, and are intended to be within the scope of the following claims.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a”, “an”, and the include plural referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

### REFERENCES

[reference 1] Advanced video coding for generic audiovisual services, November 2007SMPTE 421M, “VC-1 Compressed Video Bitstream Format and Decoding Process,” April 2006.
[reference 2] Y. He, Y. Ye, A. Tourapis, “Reference processing using advanced motion models for video coding”, U.S. Application No. 61/366,517, July 2010.
[reference 3] ITU-T H.264, Advanced video coding for generic audiovisual services, Telecommunication Standardization Sector of ITU, March 2010.
[reference 4] A. M. Tourapis, “Enhanced Predictive Zonal Search for Single and Multiple Frame Motion Estimation”, Visual Communications and Image Processing (VCIP), pp. 1069-1079, San Jose, Calif., January 2002.
[reference 5] X. Song, T. Chiang, Y. Q. Zhang, “A scalable hierarchical motion estimation algorithm for MPEG-2”, Circuits and Systems, 1998. ISCAS '98. Proceedings of the 1998 IEEE International Symposium on Volume 4, Date: 31 May-3 Jun. 1998, Pages: 126-129 vol. 4.
[reference 6] J. Bankoski, P. Wilkins, Y. Xu, “TECHNICAL OVERVIEW OF VP8, AN OPEN SOURCE VIDEO CODEC FOR THE WEB”, 2011 International Workshop on Acoustics and Video Coding and Communication.
[reference 7] H.-Y. Cheong, A. M. Tourapis, J. Llach, J. Boyce, “Adaptive Spatio-Temporal Filtering for Video De-noising”, IEEE 2004 International Conference on Image Processing (ICIP), pp. 965-968.

1-62. (canceled)

63. A method for selecting a motion vector for motion compensated prediction, the selected motion vector being associated with a particular reference picture and for use with a particular region of an input picture in a sequence of pictures, the method comprising:
a) providing the sequence of pictures, wherein each picture is adapted to be partitioned into one or more regions;
b) providing a plurality of reference pictures from a reference picture buffer;
c) for the particular reference picture in the plurality of reference pictures, performing motion estimation on the particular region based on the particular reference picture to obtain at least one motion vector, wherein each motion vector is based on a predictor selected from the group consisting of a spatial intra-layer predictor, a temporal predictor, a fixed predictor, and a derived predictor;
d) generating a prediction region based on the particular region and a particular motion vector among the at least one motion vector;
e) calculating an error metric between the particular region and the prediction region;
f) comparing the error metric with a set threshold;
g) selecting the particular motion vector if the error metric is below the set threshold, thus selecting the motion vector for motion compensated prediction associated with the particular reference picture and for use with the particular region; and
h) iterating d) through g) for each remaining motion vector in the at least one motion vector and selecting a motion vector associated with a error metric below the set threshold or a motion vector associated with a minimum error metric.

64. The method according to claim 63, further comprising:
characterizing a relationship between each motion vector in the at least one motion vector and its associated error metric; and
utilizing information of the motion vector, the error metric, and the relationship between the motion vector and error metric in performing motion estimation on the sequence of pictures, wherein information from the performing motion estimation on the sequence of pictures is adapted to be utilized in performing one or more of encoding, pre-processing, and post-processing.

65. A method for selecting a motion vector for motion compensated prediction, the selected motion vector being associated with a particular reference picture and for use with a particular region of an input picture in a sequence of pictures, the method comprising:
a) providing the sequence of pictures, wherein each picture is adapted to be partitioned into one or more regions;
b) providing a plurality of reference pictures from a reference picture buffer;
c) for each input picture in the sequence of pictures, providing at least a first hierarchical layer and a second hierarchical layer, each hierarchical layer associated with each input picture in the sequence of pictures at a set resolution;
d) providing motion information associated with the second hierarchical layer;
e) for the particular reference picture in the plurality of reference pictures, performing motion estimation on the particular region at the first hierarchical layer based on the particular reference picture to obtain at least one first hierarchical layer motion vector, wherein each first hierarchical layer motion vector is based on a predictor selected from the group consisting of a spatial intra-layer predictor, an inter-layer predictor, a temporal predictor, a fixed predictor, and a derived predictor associated with the first hierarchical layer;
f) generating a prediction region based on a particular first hierarchical layer motion vector and the particular region of the input picture;
g) calculating an error metric between the particular region and the prediction region;
h) comparing the error metric with a set threshold;
i) selecting the particular first hierarchical layer motion vector if the error metric is below the set threshold, thus selecting the motion vector for motion compensated prediction associated with the particular reference picture and for use with the particular region; and
j) iterating f) through i) for each remaining first hierarchical layer motion vector in the at least one first hierarchical layer motion vector and selecting a first hierarchical layer motion vector associated with an error metric below the set threshold or a first hierarchical layer motion vector associated with a minimum error metric.

66. The method according to claim 65, further comprising setting an elimination threshold for the error metric of the first hierarchical layer motion vector and eliminating the first hierarchical layer motion vector when the error metric associated with the first hierarchical layer motion vector is above the elimination threshold.

67. The method according to claim 66, wherein the selecting a first hierarchical layer motion vector is further based on comparing differences between one first hierarchical layer motion vector and other first hierarchical layer motion vectors of the at least one first hierarchical layer motion vector.

68. A method for performing hierarchical motion estimation on a particular region of an input picture in a sequence of pictures, each input picture adapted to be partitioned into one or more regions, the method comprising:
a) providing a plurality of reference pictures from a reference picture buffer;
b) performing downsampling and/or upsampling on the input picture at a plurality of spatial scales to generate a plurality of hierarchical layers, each hierarchical layer associated with the input picture at a set resolution;
c) for a particular reference picture in the plurality of reference pictures, performing motion estimation on the particular region at a particular hierarchical layer based on the particular reference picture to obtain at least one motion vector, wherein each motion vector is based on a predictor selected from the group consisting of a spatial intra-layer predictor, an inter-layer predictor, a temporal predictor, a fixed predictor, and a derived predictor associated with the particular hierarchical layer;
d) generating a prediction region based on a particular motion vector and the particular region at the particular hierarchical layer;
e) calculating an error metric between the particular region and the prediction region;
f) comparing the error metric with a set threshold;
g) selecting the particular motion vector if the error metric is below the set threshold, thus selecting a motion vector associated with the particular reference picture and for use with the particular region; and
h) iterating d) through g) for one or more remaining motion vectors in the at least one motion vector and selecting a motion vector associated with an error metric below the set threshold or a motion vector associated with a minimum error metric.

69. The method according to claim 68, further comprising setting an elimination threshold for the error metric of the particular motion vector associated with the particular reference picture with respect to the particular region at the particular hierarchical layer and eliminating the particular motion vector when the error metric is above the elimination threshold.

70. The method according to claim 68, wherein the selecting a motion vector is further based on comparing differences between one motion vector and other motion vectors in the at least one motion vector.

71. The method according to claim 68, further comprising:
performing a search over a search space comprising each motion vector in the at least one motion vector; and
selecting a motion vector associated with a minimum error metric.

72. The method according to claim 68, further comprising:
i) iterating c) through h) in a first looping mode;
j) iterating c) through i) in a second looping mode; and
k) iterating c) through j) in a third looping mode,
wherein each looping mode is selected from the group consisting of
performing each step for each reference picture in the plurality of reference pictures,
performing each step for each region in the input picture, and
performing each step for each hierarchical layer in the plurality of hierarchical layers,
wherein each of the first, second, and third looping modes is a different looping mode.

73. The method according to claim 72, wherein the performing of each step for each reference picture in the plurality of reference pictures further comprises setting an elimination threshold for the error metric of each reference picture and eliminating the reference picture when the error metric is above the elimination threshold.

74. The method according to claim 73, wherein each of i) through k) further comprises:
performing a search over one or more search spaces comprising each motion vector in the at least one motion vector; and
selecting a motion vector associated with a minimum error metric.

75. The method according to claim 72, wherein the performing each step for each hierarchical layer in the plurality of hierarchical layers starts from an uppermost hierarchical layer and ends with a lowermost hierarchical layer, wherein the uppermost hierarchical layer is associated with a lowest resolution of the particular region and the lowermost hierarchical layer is associated with a highest resolution of the particular region.

76. The method according to claim 71, wherein the search is an enhanced predictive zonal search.

77. The method according to claim 74, wherein the search is an enhanced predictive zonal search, and wherein the search to be performed at a particular hierarchical layer is selected based on resolution associated with the particular hierarchical layer.

78. A method, comprising:
performing the hierarchical motion estimation according claim 68 to generate a plurality of motion vectors for an input picture with respect to a particular reference picture, each motion vector being associated with a region in the input picture, and wherein the performing of weighted predictions comprises:
deriving a weighted prediction parameter and offset for each region of the input picture based on a prediction picture generated based on the motion vector associated with each region;
calculating an error metric for all regions of the input picture for each weighted prediction parameter and offset;
selecting the weighted prediction parameter and offset associated with a lowest error metric; and
assigning the weighted prediction parameter and offset to the particular reference picture.

79. The method according to claim 78, wherein the performing the hierarchical motion estimation according to any one of the preceding claims to generate a plurality of motion vectors is for an input picture with respect to a particular reference picture, each motion vector being associated with a region in the input picture, and wherein the performing of weighted predictions comprises:
deriving a weighted prediction parameter and offset for each region of the input picture based on a prediction picture generated based on the motion vector associated with each region;
calculating an error metric for all regions of the input picture for each weighted prediction parameter and offset;
selecting the weighted prediction parameter and offset associated with a lowest error metric; and
assigning the weighted prediction parameter and offset to the particular reference picture.

80. A method for encoding input image data into a bitstream, comprising:
performing the method according to claim 68 to generate a plurality of motion vectors;
selecting a coding mode based on the plurality of motion vectors, wherein the selecting is based on the input image data and the plurality of motion vectors, and wherein the coding mode comprises:
intra prediction, and
motion estimation and motion compensation;
performing the selected coding mode on the input image data to provide prediction data;
taking a difference between the input image data and the prediction data to provide residual information;
performing transformation and quantization on the residual information to obtain processed residual information; and
performing entropy encoding on the processed residual information to generate the bitstream,
wherein the motion estimation and motion compensation are based on reference data in a reference buffer and the plurality of motion vectors.

81. A method for generating reference data, the reference data adapted to be stored in a reference buffer, the method comprising:
performing the method according to claim 68, thus generating a plurality of motion vectors;
selecting a coding mode, based on the plurality of motion vectors, wherein the selecting is based on the input image data and the plurality of motion vectors, and wherein the coding mode comprises:
intra prediction, and
motion estimation and motion compensation,
performing the selected coding mode on the input image data to provide prediction pictures;
taking a difference between the input image data and the prediction data to provide residual information;
performing transformation and quantization on the residual information to obtain processed residual information;
performing inverse quantization and inverse transformation on the processed residual information to obtain non-transformed residual information; and
generating reconstructed data based on the non-transformed residual information and the prediction data, wherein the reconstructed data is adapted to be stored as reference data in a reference buffer,
wherein the intra prediction is based on the reconstructed data and the motion estimation and motion compensation are based on reference data in the reference buffer and the plurality of motion vectors.

82. An encoder adapted to receive input video data and output a bitstream, the encoder comprising:
a hierarchical motion estimation unit configured to generate a plurality of motion vectors;
a mode selection unit, wherein the mode selection unit is adapted to determine mode decisions based on the input video data and the plurality of motion vectors from the hierarchical motion estimation unit, and wherein the mode selection unit is adapted to generate prediction data from intra prediction and/or motion estimation and compensation;
an intra prediction unit connected with the mode selection unit, wherein the intra prediction unit is adapted to generate intra prediction data based on the input video data;
a motion estimation and compensation unit connected with the mode selection unit, wherein the motion estimation and compensation unit is adapted to generate motion prediction data based on reference data from a reference buffer and the input video data;
a first adder unit adapted to take a difference between the input video data and the prediction data to provide residual information;
a transforming unit connected with the first adder unit, wherein the transforming unit is adapted to transform the residual information to obtain transformed information;
a quantizing unit connected with the transforming unit, wherein the quantizing unit is adapted to quantize the transformed information to obtain quantized information; and
an entropy encoding unit connected with the quantizing unit, wherein the entropy encoding unit is adapted to generate the bitstream from the quantized information.
